(19) United States
(12) Patent Application Publication
(10) Pub. No.: US 2008/0297487 A1
(43) Pub. Date: Dec. 4, 2008

(54) DISPLAY INTEGRATED PHOTODIODE MATRIX

(75) Inventors: Steve Porter HOTELLING, San Jose, CA (US); Brian Lynch, Portola Valley, CA (US); Jeffrey Traer Bernstein, San Francisco, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(73) Assignee: Apple Inc., Cupertino, CA (US)

(21) Appl. No.: 12/172,998

(22) Filed: Jul. 14, 2008

Related U.S. Application Data
(63) Continuation-in-part of application No. 11/649,998, filed on Jan. 3, 2007.

(51) Int. Cl. G06F 3/041

(52) U.S. Cl. 345/173

(57) ABSTRACT

The use of one or more proximity sensors alone or in combination with one or more touch sensors in a multi-touch panel to detect the presence of a finger, body part or other object and control or trigger one or more functions in accordance with an “image” of touch provided by the sensor outputs is disclosed. In some embodiments, one or more infrared (IR) proximity sensors can be driven with a specific stimulation frequency and emit IR light from one or more areas, which can in some embodiments correspond to “pixel” locations. The reflected IR signal, if any, can be demodulated using synchronous demodulation.

### CROSS-REFERENCE TO RELATED APPLICATIONS

This application is a Continuation-In-Part (CIP) of U.S. application Ser. No. 11/649,998, filed Jan. 3, 2007, the contents of which are incorporated by reference herein in their entirety for all purposes.

### FIELD OF THE INVENTION

This relates generally to proximity sensing displays, and more particularly, to proximity sensing displays using infrared or other radiation for sensing proximity events.

### BACKGROUND OF THE INVENTION

Many types of input devices are presently available for performing operations in a computing system, such as buttons or keys, mice, trackballs, touch panels, joysticks, touch screens and the like. Touch screens, in particular, are becoming increasingly popular because of their ease and versatility of operation as well as their declining price. Touch screens can include a touch panel, which can be a clear panel with a touch-sensitive surface. The touch panel can be positioned in front of a display screen so that the touch-sensitive surface covers the viewable area of the display screen. Touch screens can allow a user to make selections and move a cursor by simply touching the display screen via a finger or stylus. In general, the touch screen can recognize the touch and position of the touch on the display screen, and the computing system can interpret the touch and thereafter perform an action based on the touch event.

State-of-the-art touch panels can detect multiple touches and near touches (within the near-field detection capabilities of their touch sensors) occurring at about the same time, and identify and track their locations. Examples of multi-touch panels are described in Applicant's co-pending U.S. application Ser. No. 10/842,862 entitled “Multipoint Touchscreen,” filed on May 6, 2004 and published as U.S. Published Application No. 2006/0097991 on May 11, 2006, the contents of which are incorporated by reference herein.

In addition to detection of touching events, the detection of fingers, palms or other objects hovering near the touch panel is desirable because it can enable the computing system to perform certain functions without necessitating actual contact with the touch panel, such as turning the entire touch panel or portions of the touch panel on or off, turning the entire display screen or portions of the display screen on or off, powering down one or more subsystems in the computing system, enabling only certain features, dimming or brightening the display screen, etc. Additionally, merely by placing a finger, hand or other object near a touch panel, virtual buttons on the display screen can be highlighted without actually triggering the “pushing” of those buttons to alert the user that a virtual button is about to be pushed should the user actually make contact with the touch panel. Furthermore, the combination of touch panel and proximity (hovering) sensor input devices can enable the computing system to perform additional functions not previously available with only a touch panel.

### SUMMARY OF THE INVENTION

This relates to the use of one or more proximity sensors in combination with one or more touch sensors in a multi-touch panel. The combination of these two different types of sensors can be used to detect the presence of one or more fingers, body parts or other objects hovering above a touch-sensitive surface or touching the touch-sensitive surface. A computing system can control or trigger one or more functions in accordance with an “image” of touch or hover provided by the sensor outputs.

Proximity sensors can, in some embodiments, include IR transmitters for transmitting IR radiation, and IR receivers for receiving IR radiation reflected by a finger or another object in proximity to the panel. To detect the location of touch events at different positions relative to the panel, multiple IR receivers can be placed on the panel. For example, a grid of IR receivers can be placed on the panel, allowing each IR receiver to serve as a “proximity pixel” indicating the presence or absence of an object in its vicinity (e.g., above it) and, in some cases, the distance between the receiver and the object. Data received from multiple receivers in of a panel can be processed to determine the positioning of one or more objects above the panel. In some embodiments, one or more infrared (IR) proximity sensors can be driven with a specific stimulation frequency and emit IR light from one or more areas, which can in some embodiments correspond to one or more touch sensor “pixel” locations. The reflected IR signal, if any, resulting from a hovering or touching object, can be demodulated using synchronous demodulation. In some embodiments, both physical interfaces (the touch and proximity sensors) can be connected to analog channels in the same electrical core to generate a value corresponding to the amount of touch or hover.

The concurrent use of a multi-touch panel along with one or more proximity sensors can provide additional detection and operational capabilities not available with a multi-touch panel by itself. For example, although only the actual touching of a finger, palm or other object upon a touch-sensitive surface or an object hovering in the near-field can generally be detected by a capacitive touch sensor, the hovering of a finger, palm or other object above a surface in the far field can be detected due to a change in the output of a photodiode amplifier in the proximity sensor. The detection of a hovering object can enable a computing system to perform certain functions that are preferentially triggered by hovering as opposed to touch. Furthermore, the use of the same analog channel design to receive both the touch sensor outputs in the multi-touch panel and the proximity sensor outputs and generate a value representative of the amount of touch or proximity of an object can enable both touch and proximity sensors to be connected to a single multi-touch subsystem for processing, eliminating the need for separate processing circuitry and reducing overall system costs.

One or more proximity sensors can be used in conjunction with a multi-touch panel. In some embodiments, an exemplary multi-touch panel can include a proximity sensor located at every touch sensor or pixel. In other embodiments, a proximity sensor can be selectively deployed at certain pixels where the detection of touch or hover may be more critical, or in a spread pattern in broad hover-sensitive areas. In still other embodiments, some rows in the multi-touch panel could be proximity sensor rows, with others being touch sensor rows.

The one or more proximity sensors can be used to implement the function of “pushing” virtual buttons appearing on the touch panel (in some embodiments with an audible confirmation) and trigger functions without actually requiring contact with the touch panel. For example, merely by hovering one's finger over a proximity sensor, a user can turn the entire touch panel on or off, turn portions of the touch panel on or off, power down a particular subsystem such as a touch subsystem, enable only certain features, dim or brighten the display, etc. In one specific example, if a user's cheek is detected near the touch panel by one or more proximity sensors, the touch panel can be powered down, and the display device can be dimmed or powered down so there is no reflection off the user's face. It can also provide the aesthetic function of dimming down the display device when brought close to the user's face, and brightening the display when moved away from the face. One or more proximity sensors can also detect that the device is inside a pocket, with similar results.

Further embodiments of the invention relate to a proximity panel that may or may not be combined with a multi-touch panel. The proximity panel can include a grid of multiple IR transmitters and a grid of multiple IR receivers. Various groups of one or more transmitters from the multiple IR transmitters can be selectively shut down while other transmitters continue operation.

The transmitters and receivers can be positioned in a single layer, or on different layers. In some embodiments, the proximity panel is provided in combination with a display. The display can be, for example, a liquid crystal display (LCD) or an organic light emitting diode display (OLED display). Other types of displays can also be used. The IR transmitters and receivers can be positioned at the same layer as the electronic elements of the display (e.g., the LEDs of an OLED display or the pixel cells of an LCD display). Alternatively, the IR transmitters and receivers can be placed at different layers.

In addition to infrared, other types of radiation can be used for proximity sensing. Existing emitters and detectors for these types of radiation can be used instead of the IR transmitters and receivers.

### BRIEF DESCRIPTION OF THE DRAWINGS

FIG. 1 illustrates an exemplary computing system using a multi-touch panel input device according to one embodiment of this invention.

FIG. 2a illustrates an exemplary capacitive multi-touch panel according to one embodiment of this invention.

FIG. 2b is a side view of an exemplary capacitive touch sensor or pixel in a steady-state (no-touch) condition according to one embodiment of this invention.

FIG. 2c is a side view of the exemplary capacitive touch sensor or pixel in a dynamic (touch) condition according to one embodiment of this invention.

FIG. 3a illustrates an exemplary analog channel (also known as an event detection and demodulation circuit) according to one embodiment of this invention.

FIG. 3b is a more detailed illustration of a virtual ground charge amplifier at the input of an analog channel, and the capacitance contributed by a capacitive touch sensor and seen by the charge amplifier according to one embodiment of this invention.

FIG. 3c illustrates an exemplary Vstim signal with multiple pulse trains each having a fixed number of pulses, each pulse train having a different frequency Fstim according to one embodiment of this invention.

FIG. 4a is an illustration of an exemplary proximity sensor according to one embodiment of this invention.

FIG. 4b illustrates an exemplary multi-touch panel with a proximity sensor located at every touch sensor or pixel according to one embodiment of this invention.

FIG. 4c illustrates an exemplary multi-touch panel with a proximity sensor selectively deployed at certain pixels where the detection of touch or hover is more critical, and in a spread pattern in other areas of the panel according to one embodiment of this invention.

FIG. 4d illustrates and exemplary multi-touch panel with some rows being proximity sensor rows and others being touch sensor rows according to one embodiment of this invention.

FIG. 4e illustrates an exemplary concurrent use of proximity sensors and a multi-touch panel according to one embodiment of this invention.

FIG. 5a illustrates an exemplary array of light emitting diode (LED)/photodiode pairs, each pair representing a portion of a proximity sensor, according to one embodiment of this invention.

FIG. 5b illustrates an exemplary array of LED/photodiode pairs, each pair representing a portion of a proximity sensor, according to one embodiment of this invention.

FIG. 6a illustrates an exemplary computing system using both a multi-touch panel and proximity sensors according to one embodiment of this invention.

FIG. 6b illustrates an exemplary mobile telephone that can include multi-touch panel, proximity sensors, display device, and other computing system blocks according to one embodiment of this invention.

FIG. 6c illustrates an exemplary digital audio/video player that can include multi-touch panel, proximity sensors, display device, and other computing system blocks according to one embodiment of this invention.

FIG. 7 is a diagram of an existing IR proximity sensing panel.

FIG. 8 is a diagram of an exemplary proximity sensing panel and two objects according to one embodiment of this invention.

FIG. 9 is a diagram of an exemplary proximity sensing panel and display combination according to one embodiment of this invention.

FIG. 10 is another diagram of an exemplary proximity sensing panel and display combination according to one embodiment of this invention.

FIG. 11 is a diagram of an exemplary proximity sensing panel according to one embodiment of the invention.

FIG. 12 is a diagram of an LCD display including a proximity sensing functionality.

### DETAILED DESCRIPTION OF THE PREFERRED EMBODIMENT

In the following description of preferred embodiments, reference is made to the accompanying drawings, in which it is shown by way of illustration specific embodiments in which the invention can be practiced. It is to be understood that other embodiments can be used and structural changes can be made without departing from the scope of the embodiments of this invention.

One or more proximity sensors together with a plurality of touch sensors in a multi-touch panel can enable a computing system to sense both multi-touch events (the touching of fingers or other objects upon a touch-sensitive surface at distinct locations at about the same time) and hover events (the no-touch, close proximity hovering of fingers or other objects above a touch-sensitive surface but outside the near-field detection capabilities of touch sensors), as well as perform additional functions not previously available with touch sensors alone.

Although some embodiments of this invention may be described herein in terms of proximity sensors in combination with capacitive touch sensors in a multi-touch panel, it should be understood that embodiments of this invention are not so limited, but are generally applicable to the use of proximity sensors with any type of multi-touch sensor technology that can include resistive touch sensors, surface acoustic wave touch sensors, electromagnetic touch sensors, near field imaging touch sensors, and the like. Furthermore, although the touch sensors in the multi-touch panel may be described herein in terms of an orthogonal array of touch sensors having rows and columns, it should be understood that embodiments of this invention are not limited to orthogonal arrays, but can be generally applicable to touch sensors arranged in any number of dimensions and orientations, including diagonal, concentric circle, and three-dimensional and random orientations. In addition, it is noted that some touch sensors, particularly capacitive sensors, can detect some hovering or proximity in the near field. Thus, the term “proximity sensor,” as used herein, should be understood to be a proximity sensor that is able to detect hovering objects outside the near-field detection capabilities of touch sensors.

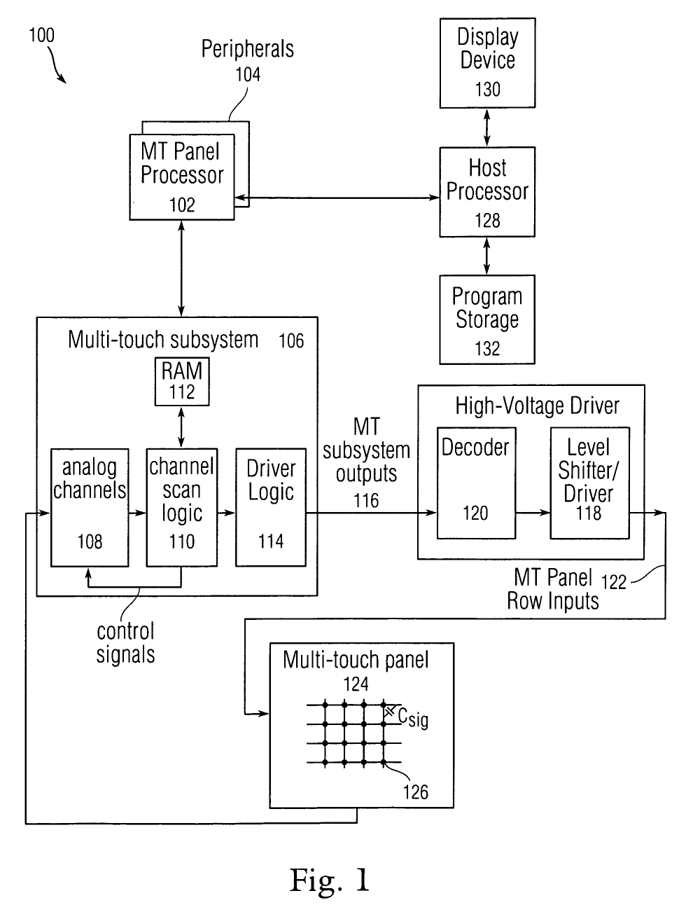

Multi-touch touch-sensitive panels according to one embodiment of this invention can detect multiple touches (touch events or contact points) that occur at about the same time (and at different times), and identify and track their locations. FIG. 1 illustrates exemplary computing system 100 that uses multi-touch panel 124. Computing system 100 can include one or more multi-touch panel processors 102 and peripherals 104, and multi-touch subsystem 106. One or more processors 102 can include, for example, ARM968 processors or other processors with similar functionality and capabilities. However, in other embodiments, the multi-touch panel processor functionality can be implemented instead by dedicated logic, such as a state machine. Peripherals 104 may include, but are not limited to, random access memory (RAM) or other types of memory or storage, watchdog timers and the like. Multi-touch subsystem 106 can include, but is not limited to, one or more analog channels 108, channel scan logic 110 and driver logic 114. Channel scan logic 110 can access RAM 112, autonomously read data from the analog channels and provide control for the analog channels. This control can include multiplexing columns of multi-touch panel 124 to analog channels 108. In addition, channel scan logic 110 can control the driver logic and stimulation signals being selectively applied to rows of multi-touch panel 124. In some embodiments, multi-touch subsystem 106, multi-touch panel processor 102 and peripherals 104 can be integrated into a single application specific integrated circuit (ASIC).

Driver logic 114 can provide multiple multi-touch subsystem outputs 116 and can present a proprietary interface that drives high voltage driver, which is comprised of decoder 120 and subsequent level shifter and driver stage 118, although level-shifting functions could be performed before decoder functions. Level shifter and driver 118 can provide level shifting from a low voltage level (e.g. CMOS levels) to a higher voltage level, providing a better signal-to-noise (S/N) ratio for noise reduction purposes. Decoder 120 can decode the drive interface signals to one out of N outputs, whereas N is the maximum number of rows in the panel. Decoder 120 can be used to reduce the number of drive lines needed between the high voltage driver and multi-touch panel 124. Each multi-touch panel row input 122 can drive one or more rows in multi-touch panel 124. In some embodiments, driver 118 and decoder 120 can be integrated into a single ASIC. However, in other embodiments driver 118 and decoder 120 can be integrated into driver logic 114, and in still other embodiments driver 118 and decoder 120 can be eliminated entirely.

Multi-touch panel 124 can in some embodiments include a capacitive sensing medium having a plurality of row traces or driving lines and a plurality of column traces or sensing lines, although other sensing media may also be used. The row and column traces may be formed from a transparent conductive medium, such as Indium Tin Oxide (ITO) or Antimony Tin Oxide (ATO), although other transparent and non-transparent materials, such as copper, can also be used. In some embodiments, the row and column traces can be formed on opposite sides of a dielectric material, and can be perpendicular to each other, although in other embodiments other non-orthogonal orientations are possible. For example, in a polar coordinate system, the sensing lines can be concentric circles and the driving lines can be radially extending lines (or vice versa). It should be understood, therefore, that the terms “row” and “column,” “first dimension” and “second dimension,” or “first axis” and “second axis” as used herein are intended to encompass not only orthogonal grids, but the intersecting traces of other geometric configurations having first and second dimensions (e.g. the concentric and radial lines of a polar-coordinate arrangement). It should also be noted that in other embodiments, the rows and columns can be formed on a single side of a substrate, or can be formed on two separate substrates separated by a dielectric material. In some embodiments, the dielectric material can be transparent, such as glass, or can be formed from other materials, such as mylar. An additional dielectric cover layer may be placed over the row or column traces to strengthen the structure and protect the entire assembly from damage.

At the “intersections” of the traces, where the traces pass above and below (cross) each other (but do not make direct electrical contact with each other), the traces essentially form two electrodes (although more than two traces could intersect as well). Each intersection of row and column traces can represent a capacitive sensing node and can be viewed as picture element (pixel) 126, which can be particularly useful when multi-touch panel 124 is viewed as capturing an “image” of touch. (In other words, after multi-touch subsystem 106 has determined whether a touch event has been detected at each touch sensor in the multi-touch panel, the pattern of touch sensors in the multi-touch panel at which a touch event occurred can be viewed as an “image” of touch (e.g. a pattern of fingers touching the panel).) The capacitance between row and column electrodes appears as a stray capacitance on all columns when the given row is held at DC and as a mutual capacitance Csig when the given row is stimulated with an AC signal. The presence of a finger or other object near or on the multi-touch panel can be detected by measuring changes to Csig. The columns of multi-touch panel 124 can drive one or more analog channels 108 (also referred to herein as event detection and demodulation circuits) in multi-touch subsystem 106. In some embodiments, each column is coupled to one dedicated analog channel 108. However, in other embodiments, the columns may be couplable via an analog switch to a fewer number of analog channels 108.

Computing system 100 can also include host processor 128 for receiving outputs from multi-touch panel processor 102 and performing actions based on the outputs that may include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 128 may also perform additional functions that may not be related to multi-touch panel processing, and can be coupled to program storage 132 and display device 130 such as an LCD display for providing a user interface (UI) to a user of the device.

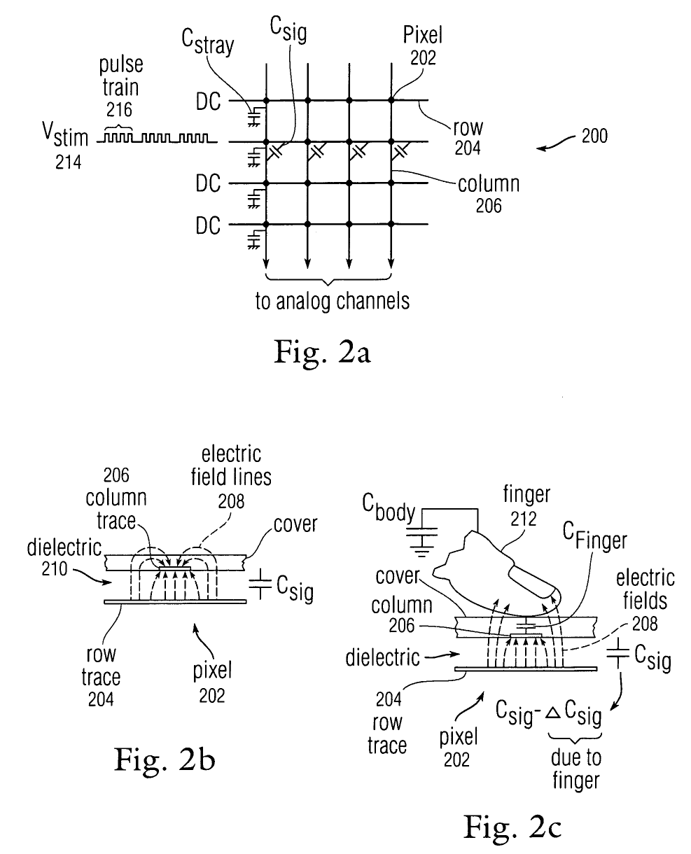

FIG. 2a illustrates exemplary capacitive multi-touch panel 200. FIG. 2a indicates the presence of a stray capacitance Cstray at each pixel 202 located at the intersection of a row 204 and a column 206 trace (although Cstray for only one column is illustrated in FIG. 2 for purposes of simplifying the figure). Note that although FIG. 2a illustrates rows 204 and columns 206 as being substantially perpendicular, they need not be so aligned, as described above. In the example of FIG. 2a, AC stimulus Vstim 214 is being applied to one row, with all other rows connected to DC. The stimulus causes a charge to be injected into the column electrodes through mutual capacitance at the intersecting points. This charge is Qsig=Csig×Vstm. Each of columns 206 may be selectively connectable to one or more analog channels (see analog channels 108 in FIG. 1).

FIG. 2b is a side view of exemplary pixel 202 in a steady-state (no-touch) condition. In FIG. 2b, an electric field of electric field lines 208 of the mutual capacitance between column 206 and row 204 traces or electrodes separated by dielectric 210 is shown.

FIG. 2c is a side view of exemplary pixel 202 in a dynamic (touch) condition. In FIG. 2c, finger 212 has been placed near pixel 202. Finger 212 is a low-impedance object at signal frequencies, and has an AC capacitance Cfinger from the column trace 204 to the body. The body has a self-capacitance to ground Cbody of about 200 pF, where Cbody is much larger than Cfinger. If finger 212 blocks some electric field lines 208 between the row and column electrodes (those fringing fields that exit the dielectric and pass through the air above the row electrode), those electric field lines are shunted to ground through the capacitance path inherent in the finger and the body, and as a result, the steady state signal capacitance Csig is reduced by ΔCsig. In other words, the combined body and finger capacitance act to reduce Csig by an amount ΔCsig (which can also be referred to herein as Csig_sense), and can act as a shunt or dynamic return path to ground, blocking some of the electric fields as resulting in a reduced net signal capacitance. The signal capacitance at the pixel becomes Csig-ΔCsig, where Csig represents the static (no touch) component and ΔCsig represents the dynamic (touch) component. Note that Csig-ΔCsig may always be nonzero due to the inability of a finger, palm or other object to block all electric fields, especially those electric fields that remain entirely within the dielectric material. In addition, it should be understood that as a finger is pushed harder or more completely onto the multi-touch panel, the finger can tend to flatten, blocking more and more of the electric fields, and thus ΔCsig can be variable and representative of how completely the finger is pushing down on the panel (i.e. a range from “no-touch” to “full-touch”).

Referring again to FIG. 2a, as mentioned above, Vstim signal 214 can be applied to a row in multi-touch panel 200 so that a change in signal capacitance can be detected when a finger, palm or other object is present. Vstim signal 214 can include one or more pulse trains 216 at a particular frequency, with each pulse train including of a number of pulses. Although pulse trains 216 are shown as square waves, other waveshapes such as sine waves can also be employed. A plurality of pulse trains 216 at different frequencies can be transmitted for noise reduction purposes to detect and avoid noisy frequencies. Vstim signal 214 essentially injects a charge into the row, and can be applied to one row of multi-touch panel 200 at a time while all other rows are held at a DC level. However, in other embodiments, the multi-touch panel may be divided into two or more sections, with Vstim signal 214 being simultaneously applied to one row in each section and all other rows in that region section held at a DC voltage.

Each analog channel coupled to a column measures the mutual capacitance formed between that column and the row. This mutual capacitance is comprised of the signal capacitance Csig and any change Csig_sense in that signal capacitance due to the presence of a finger, palm or other body part or object. These column values provided by the analog channels may be provided in parallel while a single row is being stimulated, or may be provided in series. If all of the values representing the signal capacitances for the columns have been obtained, another row in multi-touch panel 200 can be stimulated with all others held at a DC voltage, and the column signal capacitance measurements can be repeated. Eventually, if Vstim has been applied to all rows, and the signal capacitance values for all columns in all rows have been captured (i.e. the entire multi-touch panel 200 has been “scanned”), a “snapshot” of all pixel values can be obtained for the entire multi-touch panel 200. This snapshot data can be initially saved in the multi-touch subsystem, and later transferred out for interpretation by other devices in the computing system such as the host processor. As multiple snapshots are obtained, saved and interpreted by the computing system, it is possible for multiple touches to be detected, tracked, and used to perform other functions.

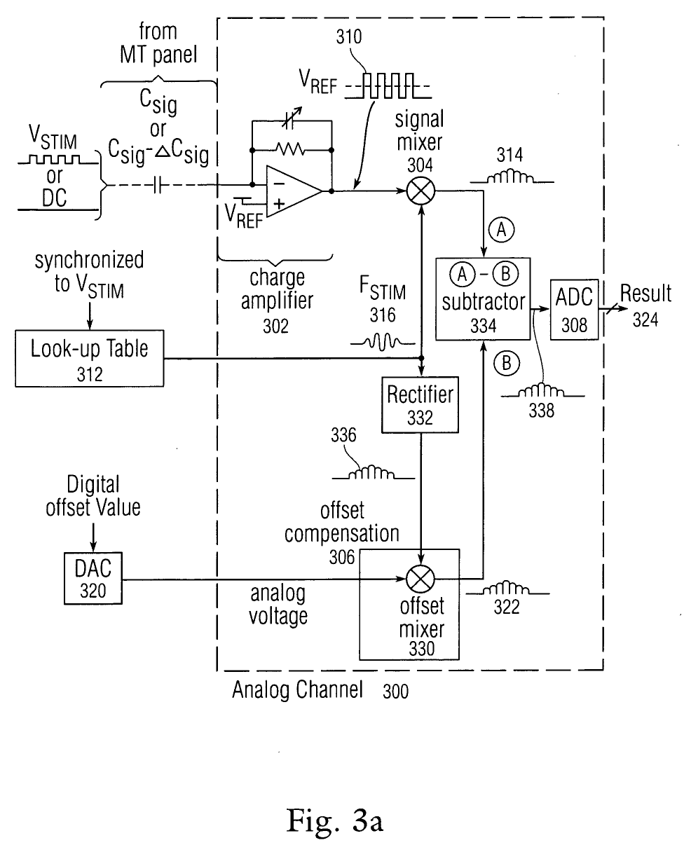

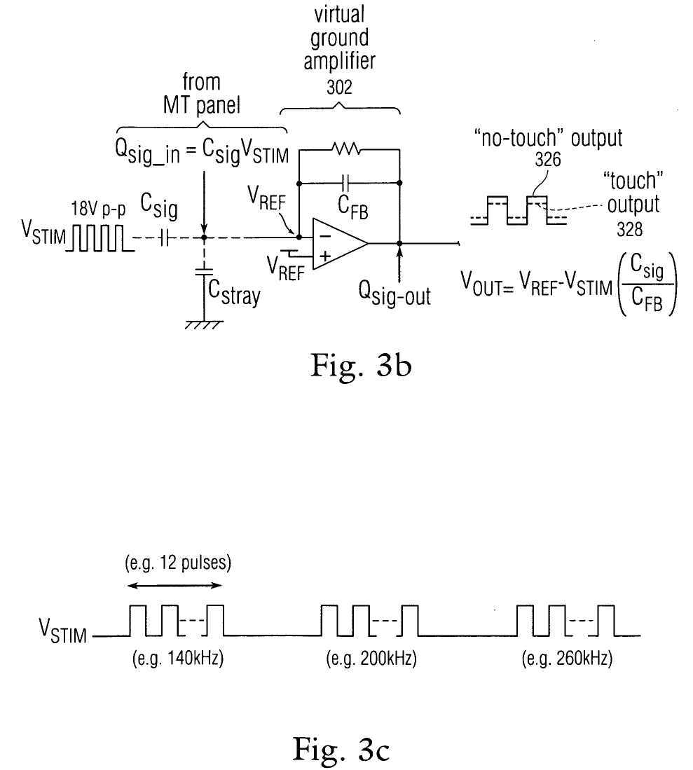

FIG. 3a illustrates exemplary analog channel or event detection and demodulation circuit 300. One or more analog channels 300 can be present in the multi-touch subsystem. One or more columns from a multi-touch panel can be connectable to each analog channel 300. Each analog channel 300 can include virtual-ground charge amplifier 302, signal mixer 304, offset compensation 306, rectifier 332, subtractor 334, and analog-to-digital converter (ADC) 308. FIG. 3a also shows, in dashed lines, the steady-state signal capacitance Csig that can be contributed by a multi-touch panel column connected to analog channel 300 when an input stimulus Vstim is applied to a row in the multi-touch panel and no finger, palm or other object is present, and the dynamic signal capacitance Csig-ΔCsig that can appear when a finger, palm or other object is present.

Vstim, as applied to a row in the multi-touch panel, can be generated as a burst of square waves or other non-DC signaling in an otherwise DC signal, although in some embodiments the square waves representing Vstim can be preceded and followed by other non-DC signaling. If Vstim is applied to a row and a signal capacitance is present at a column connected to analog channel 300, the output of charge amplifier 302 can be pulse train 310 centered at Vref with a peak-to-peak (p-p) amplitude in the steady-state condition that is a fraction of the p-p amplitude of Vstim, the fraction corresponding to the gain of charge amplifier 302. For example, if Vstim includes 18V p-p pulses and the gain of the charge amplifier is 0.1, then the output of the charge amplifier can be 1.8V p-p pulses. This output can be mixed in signal mixer 304 with demodulation waveform Fstim 316.

Because Vstim can create undesirable harmonics, especially if formed from square waves, demodulation waveform Fstim 316 can be a Gaussian sine wave in an otherwise DC signal that is digitally generated from look-up table (LUT) 312 or other digital logic and synchronized to Vstim. In some embodiments, Fstim 316 can be tunable in frequency and amplitude by selecting different digital waveforms in LUT 312 or generating the waveforms differently using other digital logic. Signal mixer 304 can demodulate the output of charge amplifier 310 by subtracting Fstim 316 from the output to provide better noise rejection. Signal mixer 304 can reject all frequencies outside the passband, which can in one example be about +/−30 kHz around Fstim. This noise rejection can be beneficial in noisy environment with many sources of noise, such as 802.11, Bluetooth and the like, all having some characteristic frequency that can interfere with the sensitive (femtofarad level) analog channel 300. Signal mixer 304 is essentially a synchronous rectifier as the frequency of the signal at its inputs is the same, and as a result, signal mixer output 314 is essentially a rectified Gaussian sine wave.

Offset compensation 306 can then be applied to signal mixer output 314, which can remove the effect of the static Csig, leaving only the effect of ΔCsig appearing as result 324. Offset compensation 306 can be implemented using offset mixer 330. Offset compensation output 322 can be generated by rectifying Fstim 316 using rectifier 332, and mixing rectifier output 336 with analog voltage from a digital-to-analog converter (DAC) 320 in offset mixer 330. DAC 320 can generate the analog voltage based on a digital value selected to increase the dynamic range of analog channel 300. Offset compensation output 322, which can be proportional to the analog voltage from DAC 320, can then be subtracted from signal mixer output 314 using subtractor 334, producing subtractor output 338 which can be representative of the change in the AC capacitance ΔCsig that occurs when a capacitive sensor on the row being stimulated has been touched. Subtractor output 338 is then integrated and can then be converted to a digital value by ADC 308. In some embodiments, integrator and ADC functions are combined and ADC 308 may be an integrating ADC, such as a sigma-delta ADC, which can sum a number of consecutive digital values and average them to generate result 324.

FIG. 3b is a more detailed view of charge amplifier (a virtual ground amplifier) 302 at the input of an analog channel, and the capacitance that can be contributed by the multi-touch panel (see dashed lines) and seen by the charge amplifier. As mentioned above, there can be an inherent stray capacitance Cstray at each pixel on the multi-touch panel. In virtual ground amplifier 302, with the + (noninverting) input tied to Vref, the − (inverting) input is also driven to Vref, and a DC operating point is established. Therefore, regardless of how much Csig is present, the − input is always driven to Vref. Because of the characteristics of virtual ground amplifier 302, any charge Qstray that is stored in Cstray is constant, because the voltage across Cstray is kept constant by the charge amplifier. Therefore, no matter how much stray capacitance Cstray is added to the − input, the net charge into Cstray will always be zero. Therefore the input charge Qsig_sense=(Csig−ΔCsig_sense)Vstim is zero when the corresponding row is kept at DC and is purely a function of Csig and Vstim when the corresponding row is stimulated. In either case, because there is no charge across Csig, the stray capacitance is rejected, and it essentially drops out of any equations. Thus, even with a hand over the multi-touch panel, although Cstray can increase, the output will be unaffected by the change in Cstray.

The gain of virtual ground amplifier 302 is usually small (e.g. 0.1) and is equivalent to the ratio of Csig (e.g. 2 pF) and feedback capacitor Cfb (e.g. 20 pF). The adjustable feedback capacitor Cfb converts the charge Qsig to the voltage Vout. Therefore, the output Vout of virtual ground amplifier 302 is a voltage that is equivalent to the ratio of −Csig/Cfb multiplied by Vstim referenced to Vref. The high voltage Vstim pulses can therefore appear at the output of virtual ground amplifier 302 as much smaller pulses having an amplitude identified by reference character 326. However, when a finger is present, the amplitude of the output can be reduced as identified by reference character 328, because the signal capacitance is reduced by ΔCsig.

FIG. 3c illustrates an exemplary Vstim signal with multiple pulse trains each having a fixed number of pulses, each pulse train having a different frequency Fstim (e.g. 140 kHz, 200 kHz, and 260 kHz). With multiple pulse trains at different frequencies, one or more results can be obtained at each frequency. If a static interferer is present at a particular frequency, the results at that frequency can be corrupted as compared to the results obtained at the other two frequencies, and those results can be eliminated. The results at the remaining two frequencies can be averaged to compute the result.

The multiple Fstims may be applied in different ways to the multi-touch panel. In some embodiments, N columns can be connected to one analog channel via N:1 demultiplexer. A given row would then have to be stimulated N times to acquire Csig for all columns and then repeated for the other two frequencies. In this embodiment, fewer channels are needed but it takes longer to process an image. In other embodiments, one channel can be allotted for each column. A given row only has to be stimulated once to acquire Csig for all columns and then repeated for the other two frequencies. This arrangement can be faster then the previous arrangement; however, it takes more dedicated channels, which may be necessary for large multi-touch panels and when communications are USB, which could drop packets if too slow. After an entire “image” is captured, it can be processed. In further embodiments, multiple stimuli (scan circuits) can be applied to different rows at the same time to speed up the process. Fstim can be programmable. In some embodiments, a lookup table can be used to synthesize a demodulation waveform. The feedback capacitance Cfb and offset can also be programmable.

Embodiments of this invention relate to the use of one or more proximity sensors in combination with one or more touch sensors in a multi-touch panel to detect the presence of a finger, body part or other object and control or trigger one or more functions in accordance with an “image” of touch provided by the sensor outputs. In some embodiments, one or more infrared (IR) proximity sensors or other types of proximity sensors can be driven with a specific stimulation frequency and emit IR light from one or more areas, which can in some embodiments correspond to one or more touch sensor “pixel” locations. The reflected IR signal, if any, can be demodulated using synchronous demodulation. In some embodiments, both physical interfaces (the touch and proximity sensors) can be connected to analog channels in the same electrical core.

The concurrent use of a multi-touch panel along with one or more proximity sensors can provide additional detection and operational capabilities not available with a multi-touch panel by itself. For example, although only the actual touching of a finger, palm or other object upon a touch-sensitive surface can be detected by a touch sensor, the mere hovering of a finger, palm or other object above a surface can be detected due to a change in the output of a photodiode amplifier in the proximity sensor. The detection of a hovering object can enable a computing system to perform certain functions that are preferentially triggered by hovering as opposed to touch. Furthermore, the use of the same analog channel design to receive both the touch sensor outputs in the multi-touch panel and the proximity sensor outputs and generate a value representative of the amount of touch or proximity of an object can enable both touch and proximity sensors to be connected to a single multi-touch subsystem for processing, eliminating the need for separate processing circuitry and reducing overall system costs.

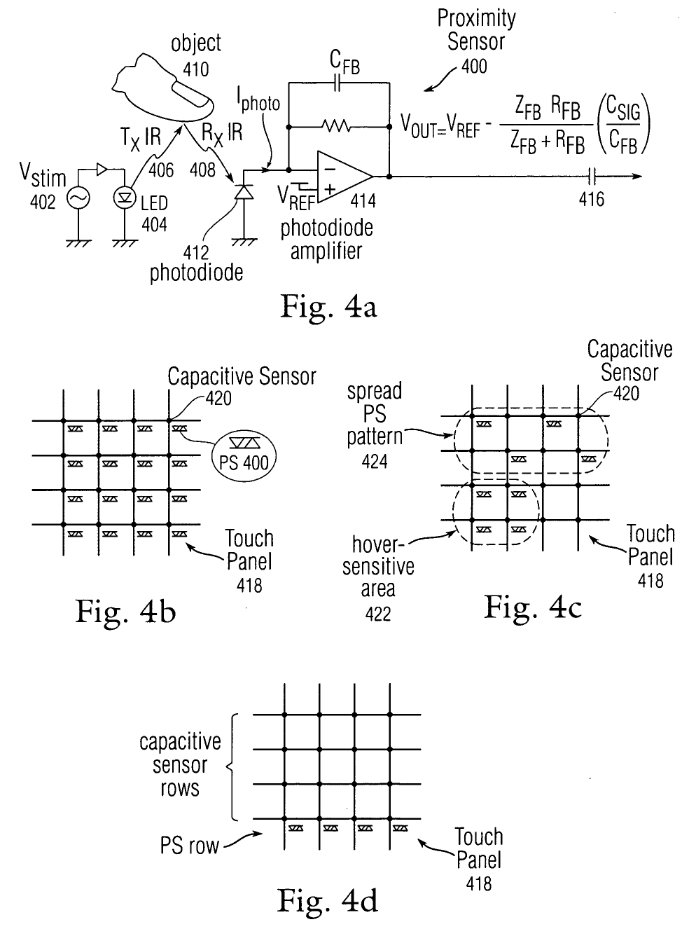

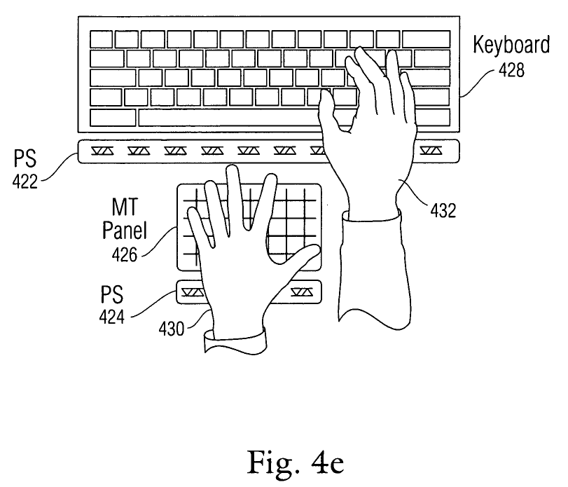

FIG. 4a is an illustration of exemplary proximity sensor 400 according to some embodiments of this invention. Proximity sensors 400 can detect one or more fingers, a palm or other object touching the multi-touch panel or hovering over the multi-touch panel in the far field without touching it. Proximity sensor 400 can include source Vstim 402 that drives IR light emitting diode (LED) 404, which emits transmitted IR 406. Vstim 402 can include a burst of square waves in an otherwise DC signal, in a manner similar to the Vstim applied to the rows on the capacitive multi-touch panel as described above, although in some embodiments the square waves representing Vstim can be preceded and followed by other non-DC signaling. Reflected IR 408, which may have reflected off of a finger, palm or other object 410, can be detected by photodiode (e.g. a fast pin diode) 412 or any other device (e.g. a phototransistor or other sensing device) whose current changes as a function of received IR light. Photodiode 412 can be reversed biased to a reference voltage Vref, which can be maintained at the − input (inverting input) of photodiode amplifier 414 whose + input (non-inverting input) is tied to Vref. The photocurrent produced through the photodiode, Iphoto, also primarily passes through the parallel combination of feedback resistor Rfb and capacitor Cfb, and the output of the photodiode amplifier is Vref−(Zcfb×Rfb)×(Iphoto+Iin)/(Zcfb+Rfb), the latter term (Zcfb×Rfb)×(Iphoto+Iin)/(Zcfb+Rfb), representing the voltage drop across Rfb and Cfb where Iin is the input current to the inverting input of photodiode amplifier 414 and is usually negligible. The impedance Zcfb is frequency dependent and can be adjusted to optimize the gain of the photo amplifier for a given modulation frequency of the signal Iphoto, whereas Iphoto(t)=Ip×sin(wt) with wt=2×PI×fmod and fmod is the modulation signal, Ip is the amplitude of the modulation signal and Zcfb=−1/(jwt). The modulation frequency fmod is equivalent to the modulation frequency fstm of Vstm. The output of photodiode amplifier 414 can be AC coupled using AC coupling capacitor 416.

Note that if photodetector 412 and LED 404 are close enough to the analog channels, a separate photodiode amplifier 414 may not be required and photodiode 412 can potentially directly connected to an analog channel. A separate photodiode amplifier 414 is usually needed to prevent noise pickup when photodiode 412 is located far away from the analog channels. Because photodiode amplifier 414 provides a low impedance output, noise injection is reduced.

One or more proximity sensors can be used in conjunction with a multi-touch panel according to some embodiments of this invention. FIG. 4b illustrates exemplary multi-touch panel 418 with proximity sensor 400 located at every multi-touch sensor or pixel 420 according to some embodiments of this invention. In other embodiments, an example of which is illustrated in FIG. 4c, a proximity sensor can be selectively deployed at certain pixels where the detection of touch or hover can be more critical (see area 422), or in spread pattern 424 in broad hover-sensitive areas. For example, it may be desirable to detect the presence of an ear near the upper half of a multi-touch panel. In still other embodiments, an example of which is illustrated in FIG. 4d, some rows in the multi-touch panel could be proximity sensor rows, with others being multi-touch sensor rows.

One or more proximity sensors 400 can be used to implement the function of “pushing” virtual buttons appearing on the touch panel (in some embodiments with an audible confirmation) and trigger functions without actually making contact with the touch panel. For example, merely by hovering one's finger over a proximity sensor, a user can turn the entire touch panel on or off, turn portions of the touch panel on or off, power down a particular subsystem such as a touch subsystem, enable only certain features, dim or brighten the display, etc. In one specific example, if a cheek is detected near the touch panel by one or more proximity sensors, the touch panel can be powered down, and the display device can be dimmed or powered down so there is no reflection off the user's face. It can also provide the aesthetic function of dimming down the display device when brought close to the user's face, and brightening the display when brought away from the face. One or more proximity sensors can also detect that the device is inside a pocket, with the same result.

FIG. 4e illustrates an exemplary concurrent use of proximity sensors 422 and 424 and multi-touch panel 426 according to some embodiments of this invention. In the example of FIG. 4e, two input devices, a standard keyboard 428 and multi-touch panel 426, can be available to a user. If the user uses multi-touch panel 426 as indicated at 430, the presence of the user's palm can be detected by proximity sensor 424, while proximity sensor 422 does not detect the presence of any finger or palm. In addition, the touch sensors in multi-touch panel 426 can detect the presence of one or more fingers, a palm or other object. In this situation, the computing system can assume that the user is using multi-touch panel 426 but not keyboard 428, and thus input devices related to keyboard 428 can be powered down. However, if the user uses keyboard 428 as indicated at 432, the presence of the user's palm can be detected by proximity sensor 422, while multi-touch panel 426 and proximity sensor 424 may or may not detect the presence of the user's wrist and forearm, for example. In this situation, the computing system can assume that the user is using keyboard 428 but not multi-touch panel 426, and multi-touch panel 426 can be powered down accordingly to save on power and prevent false readings.

Referring again to exemplary proximity sensor 400 of FIG. 4a, note that LED 404 of proximity sensor 400 is driven by a single source Vstim 402, and photodiode 412 drives a single photodiode amplifier 414. This one-to-one-to-one configuration can be used in some embodiments of this invention. However, in other embodiments, the source Vstim may simultaneously drive a plurality of LEDs via a driver stage (such as a FET or bipolar transistor), and/or the photodiodes of a plurality of proximity sensors may be coupled to the same photodiode amplifier. In still other embodiments, the outputs of a plurality of photodiode amplifiers may be AC coupled together.

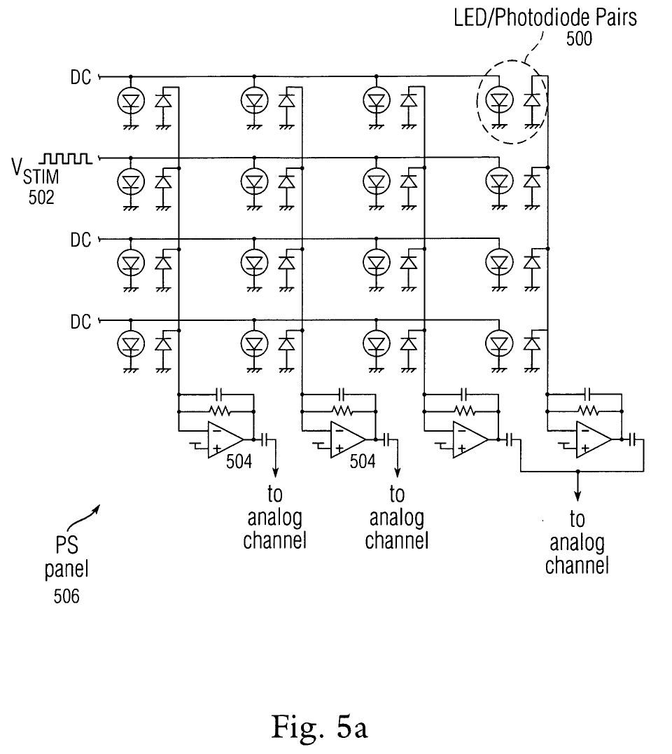

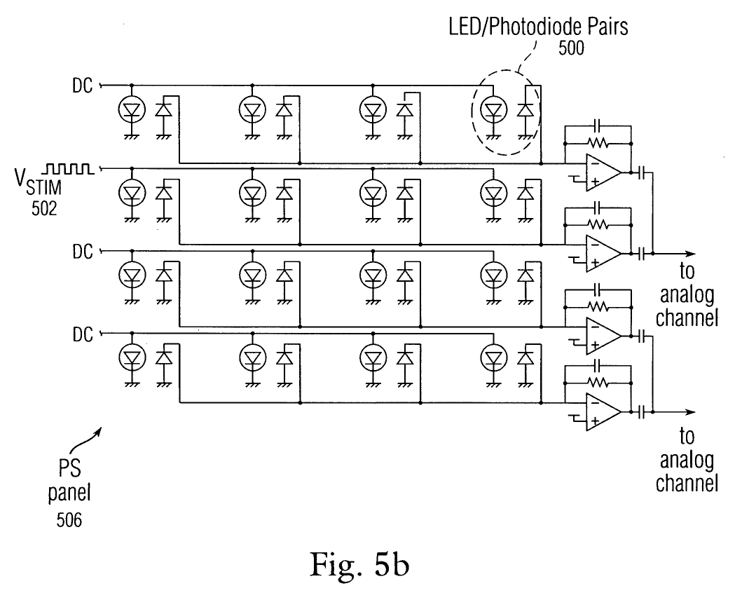

FIG. 5a illustrates an exemplary proximity sensor panel 506 that can include an array of LED/photodiode pairs 500, each pair representing a portion of a proximity sensor, according to some embodiments of this invention. In FIG. 5a, each LED/photodiode pair 500 in a particular row can be simultaneously stimulated by Vstim 502 with the other rows held at a DC voltage, and after a snapshot of the row has been captured, LED/photodiode pairs 500 in a new row can be stimulated. In the first two columns of FIG. 5a, each LED/photodiode pair 500 in a particular column can be simultaneously connected to a single photodiode amplifier 504, and each photodiode amplifier 504 can be connected to a separate analog channel of the same design as shown in FIG. 3a (i.e. the same analog channel design that can be used to detect changes in signal capacitance in a capacitive touch sensor array). In this manner, for every row being stimulated, the analog channels for each column can determine, at about the same time, whether the LED/photodiode pair in the row being stimulated has detected the presence of a finger, palm or other object. Eventually, if Vstim has been applied to all rows, and the effect of any photodiode current on all columns in all rows has been captured (i.e. the entire proximity sensor panel 506 has been “scanned”), a “snapshot” of all pixel values can be obtained for the entire proximity sensor panel 506. This snapshot data can be initially saved in the multi-touch subsystem, and later transferred out for interpretation by other devices in the computing system such as the host processor. As multiple snapshots are obtained, saved and interpreted by the computing system, it is possible for multiple hover events to be detected, tracked, and used to perform other functions.

In the last two columns of FIG. 5a, each LED/photodiode pair 500 in a particular column can be simultaneously connected to a single photodiode amplifier 504, and each photodiode amplifier 504 can be connected to the same analog channel. (Note that FIG. 5a illustrates two exemplary column configurations for purposes of illustration only, and that it should be understood that the configuration of either the first two columns or the last two columns can typically be used for an entire proximity sensor panel 506.) The configuration of the last two columns results in a composite output in which the analog channel can determine that a LED/photodiode pair in the row being stimulated has detected the presence of a finger, palm or other object, but the exact column at which the detection has occurred is unknown. This embodiment may be suitable when the presence of a finger, palm or other object needs to be detected, but the actual location of the detection need not be pinpointed.

FIG. 5b illustrates an exemplary proximity sensor panel 506 that can include an array of LED/photodiode pairs 500, each pair representing a portion of a proximity sensor, according to some embodiments of this invention. The configuration of FIG. 5b, as in the last two columns of FIG. 5a, results in a composite output in which the analog channel can determine that a LED/photodiode pair in the row being stimulated has detected the presence of a finger, palm or other object, but the exact column at which the detection has occurred is unknown. This embodiment may be suitable when the presence of a finger, palm or other object needs to be detected, but the actual location of the detection need not be pinpointed. It should be understood that any combination of proximity sensor configurations shown in FIGS. 4a, 5a and 5b can be employed in accordance with detection needs.

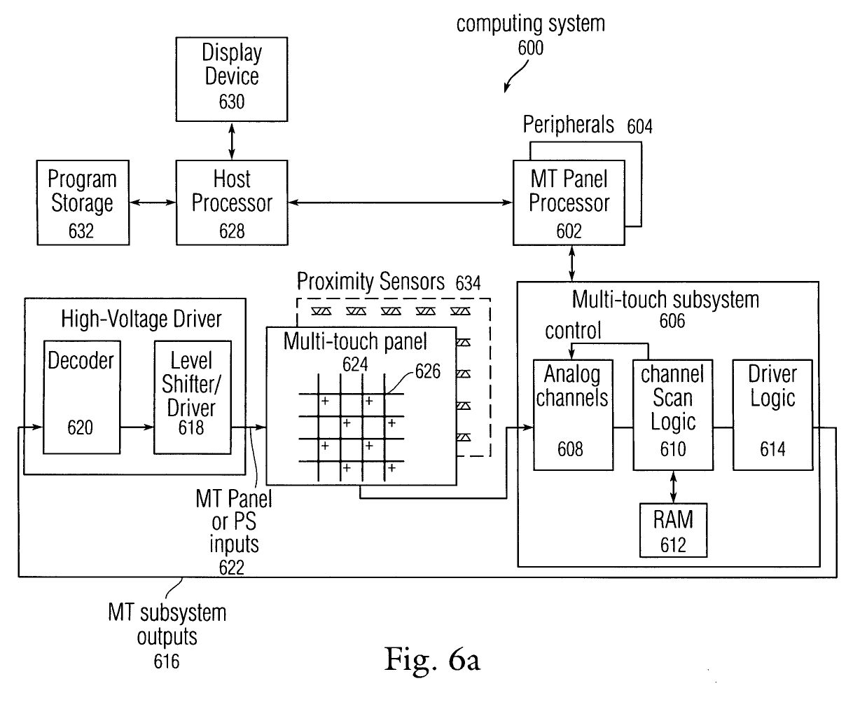

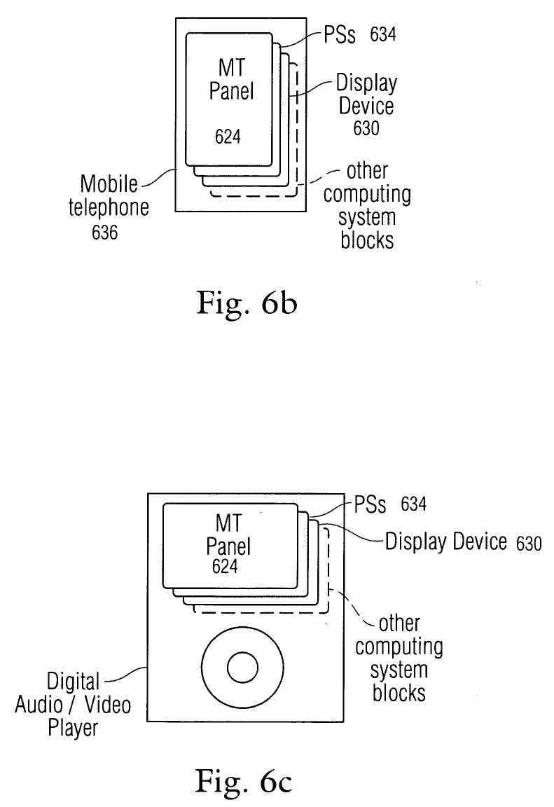

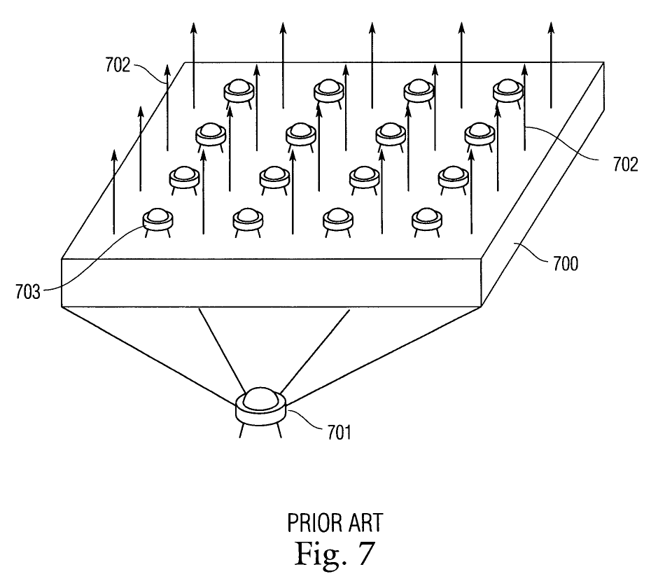

FIG. 6a illustrates an exemplary computing system 600 using both touch sensors and proximity sensors according to some embodiments of this invention. Computing system 600 may correspond to computing devices such as desktops, laptops, tablets or handhelds, including personal digital assistants (PDAs), digital music and/or video players and mobile telephones. Computing system 600 may also correspond to public computer systems such as information kiosks, automated teller machines (ATM), point of sale machines (POS), industrial machines, gaming machines, arcade machines, vending machines, airline e-ticket terminals, restaurant reservation terminals, customer service stations, library terminals, learning devices, and the like.

Computing system 600 can include one or more multi-touch panel processors 602 and peripherals 604, and multi-touch subsystem 606. Multi-touch subsystem 606 can include, but is not limited to, analog channels 608, channel scan logic 610 and driver logic 614. Channel scan logic 610 can access RAM 612, autonomously read data from the analog channels and provide control for the analog channels. This control can include multiplexing columns of multi-touch panel 624 or outputs of proximity sensors 634 to analog channels 608. In addition, channel scan logic 610 can control the driver logic and the scanning of multi-touch panel 634 and proximity sensors 634 (i.e. controlling the application of stimulation signals to individuals rows of multi-touch panel 624 and proximity sensors 634).

Driver logic 614 can provide multiple multi-touch subsystem outputs 616 and can present a proprietary interface that drives a high voltage driver, which is comprised of decoder 620 and subsequent level shifter and driver stage 618, although level-shifting functions could be performed before decoder functions. Level shifter and driver 618 can provide level shifting from a low voltage level (e.g. CMOS levels) to a higher voltage level, providing a better signal-to-noise (S/N) ratio for noise reduction purposes. Decoder 620 can decode the drive interface signals to one out of N outputs, whereas N is the maximum number of rows in the panel. Decoder 620 can be used to reduce the number of drive lines needed between the high voltage driver and multi-touch panel 624. Each multi-touch panel row input 622 can drive one or more rows in multi-touch panel 624. In some embodiments, driver 618 and decoder 620 can be integrated into a single ASIC. However, in other embodiments driver 618 and decoder 620 can be integrated into driver logic 614, and in still other embodiments driver 618 and decoder 620 can be eliminated entirely. Proximity sensors 634, although illustrated as a proximity sensor panel having evenly spaced proximity sensors for purposes of illustration only, can also be a proximity sensor panel with unevenly spaced or clustered proximity sensors, one or more rows of proximity sensors, or even a single proximity sensor. Furthermore, although FIG. 6 shows a separate multi-touch panel 624 overlaying a separate proximity sensor panel 634, in some embodiments the multi-touch and proximity sensor panels can be integrated together, or adjacent to each other without any overlap.

The array of touch-sensitive pixels 626 in multi-touch panel 624 can capture an “image” of touch. Additionally, one or more proximity sensors 634, which can be located within multi-touch panel 624 or separate from the panel, can also capture an “image” of touch or hover. In other words, after multi-touch subsystem 106 has determined whether a hover event has been detected at each proximity sensor, the pattern of proximity sensors at which a hover event occurred can be viewed as an “image” of hover (e.g. a finger-shaped pattern)). The columns of multi-touch panel 624 and one or more proximity sensors 634 can drive analog channels 608 in multi-touch subsystem 606.

Computing system 600 can also include host processor 628 for performing additional functions that may not be related to multi-touch panel processing, and can be coupled to program storage 632 which may include, but is not limited to, Read-Only Memory (ROM), Random-Access Memory (RAM), a hard disk drive, removable storage media that can include, for example, CD-ROM, DVD, PC-CARD, flash, floppy disk, magnetic tape, and a network component. Host processor 628 can also be coupled to display device 630 for providing a user interface (UI) to a user of the device. Display device 630 can be configured to display a graphical user interface (GUI) that can include a pointer or cursor as well as other information to the user. By way of example, display device 630 can be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma display and the like.

Computing system 600 in the example of FIG. 6a can implement a number of functions using both touch sensors and proximity sensors as input devices, providing enhanced capabilities not possible with only touch sensor inputs. For example, the touch sensors can be used to implement the function of “pushing” a virtual button that appears on the multi-touch panel due to an underlying LCD when a finger touches down over the virtual button, while the proximity sensors can be used to implement the function of “pushing” a virtual button when a finger merely hovers over the virtual button without actually making contact with the multi-touch panel. Additionally or alternatively, merely by placing a finger, hand or other object near a proximity sensor, a user can turn the entire multi-touch panel on or off, turn portions of the panel on or off, power down a particular subsystem such as the multi-touch subsystem, enable only certain features, dim or brighten the display, etc. Additionally or alternatively, merely by placing a finger, hand or other object near a proximity sensor, the proximity sensor can cause virtual buttons on the LCD to be highlighted without actually “pushing” those buttons, to alert the user that a virtual button is about to be pushed should the user actually touch the multi-touch panel.

FIG. 6b illustrates an exemplary mobile telephone 636 that can include multi-touch panel 624, proximity sensors 634, display device 630, and other computing system blocks in computing system 600 of FIG. 6a. In the example of FIG. 6b, if the user's cheek or ear is detected by one or more proximity sensors, computing system 600 can determine that mobile telephone 636 is being held up to the user's head, and therefore some or all of multi-touch subsystem 606, multi-touch panel 624 and proximity sensors 634 can be powered down along with display device 630 to save power. One or more proximity sensors can also detect that the device is inside a pocket, with the same result.

FIG. 6c illustrates an exemplary digital audio/video player that can include multi-touch panel 624, proximity sensors 634, display device 630, and other computing system blocks in computing system 600 of FIG. 6a.

While the combination of a proximity sensing panel with a multi-touch panel is discussed above, embodiments of the invention also include using an improved proximity sensing panel without a multi-touch panel. For example, a proximity sensing panel, such as the one shown in FIGS. 5(a) and 5(b) and discussed above, can be utilized without a multi-touch sensing panel.

FIG. 7 is an example of a conventional proximity sensing panel. Panel 700 can include a plurality of proximity sensors 703, which can be IR sensors. However, conventional proximity sensing panels usually include a single IR transmitter 701. The single IR transmitter sends IR radiation 702 out from the front surface of the panel. Various optics such as lenses, diffusers, different transmitter shapes, etc., can be utilized to ensure that radiation from transmitter 701 sends out radiation from the entire front area of the panel.

Various rays from radiation 702 can be reflected by an object in proximity to the panel, and their reflections detected by IR detectors 703. Signals produced by IR detectors 703 can then be processed to detect proximity events.

However, the conventional system of FIG. 7 requires that the entire panel transmit radiation. The IR radiation at portions of the panel cannot be selectively turned off. Furthermore, the entire panel may need to be transparent in order to allow the IR transmitter 701 to illuminate the entire panel.

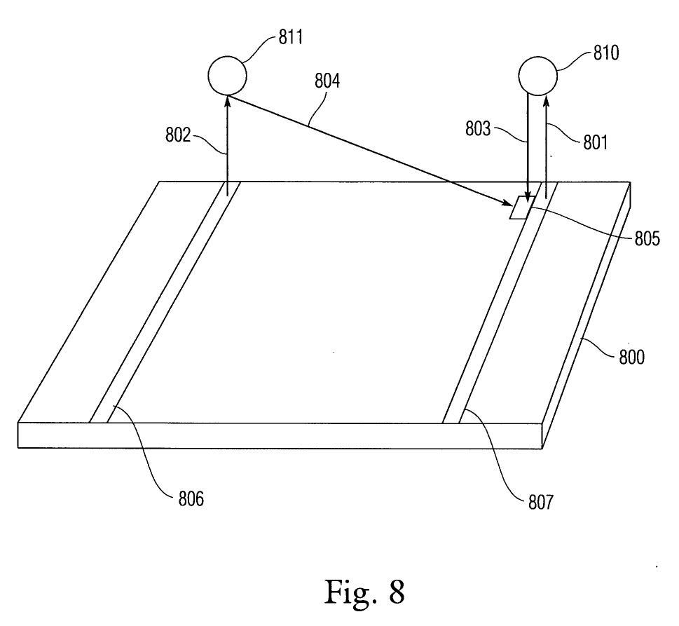

The practice of radiating the entire panel with IR radiation may result in relatively high power requirements. Furthermore, it may result in the inability to accurately detect detailed proximity events. This latter issue is shown in more detail in FIG. 8.

FIG. 8 is a diagram of a proximity panel and two objects. If the proximity panel radiates IR waves out through the entire panel, it may be difficult for the proximity panel to accurately detect certain objects. For example, if an IR receiver 805 detects radiation, the detected radiation may be radiation that is emitted from the panel as ray 801 and reflected from object 810 as ray 803. Alternatively, the radiation may be radiation emitted as ray 802 and reflected from object 811 as ray 804. Thus, any electronics processing the data received from receiver 805 may not be able to discern whether they are detecting an object in the position of object 810 or one in the position of object 811.

However, this can be addressed by the proximity panels of embodiments of the present invention, such as the panels of FIGS. 5(a) and 5(b). In embodiments of the present invention, the IR radiation can be generated at multiple IR transmitters dispersed throughout the panel. Furthermore, various IR transmitters can be selectively activated and deactivated. In the systems of FIGS. 5(a) and 5(b), the transmitters are connected to drive lines. The transmitters can be activated by sending a stimulation signal to these drive lines and deactivated by removing the stimulation signal (or sending a DC signal) to the lines. Thus, in both FIGS. 5(a) and 5(b) the second row of transmitters is active while other rows are inactive.

Referring back to FIG. 8, the above discussed features of embodiments of the present invention can be used to differentiate between the reflections of objects 810 and 811. More specifically, panel 800 can include multiple IR transmitters instead of a single transmitter that floods the entire panel with IR radiation (as in existing systems). The transmitters can be, for example, grouped into rows in a manner similar to the transmitters of FIGS. 5(a) and 5(b). Rows 806 and 807 can be two of the rows of transmitters. Individual rows of transmitters can be activated sequentially. Thus, logic that processes data received from IR receivers can be better aware of the origination point of the radiation that eventually reaches the IR receivers, and thus can better calculate the position, size, shape, etc. of proximate objects.

Furthermore, the ability to selectively turn various transmitters on and off can significantly reduce the power requirements of the panel. This can allow the panel to operate in such a manner that at any time, only a small portion of the panel's many transmitters are active. For example, the panel can “scroll” by sequentially activating a row of transmitters and keeping all others off (as discussed above). The panel can also selectively deactivate all transmitters in entire areas of the panel for a longer time if the situation does not call for these areas to perform any proximity sensing. Thus, if software running at a device including the panel 800 only requires proximity sensing above a certain portion of the panel, the panel can turn off all transmitters except for those located at that specific part of the panel to save power. Additionally the panel can selectively turn off some transmitters or groups of transmitters in order to achieve lower power at the cost of reduced accuracy.

While FIGS. 5(a) and 5(b) disclose transmitters that can only be controlled based on rows (i.e., only entire rows of transmitters can be selectively turned on and off), this need not be the case. In other embodiments, the transmitters can be controlled in other groups, or individually. A person of skill in the art would recognize that individual control of transmitters can be implemented using horizontal and vertical transmission lines which are connected to a transistor, in a manner similar to that used to individually control pixel cells in an LCD display.

As described above, the proximity sensor panel of FIGS. 5(a) and 5(b) can provide certain features as compared to certain existing types of proximity sensor panels even if not combined with a multi-touch panel. Moreover, a proximity sensor panel of the type discussed herein, even when not combined with a multi-touch panel, can nevertheless perform some of the functionality of a multi-touch panel (e.g., by sensing touch events as proximity events with very small distances).

While FIGS. 6(a), 6(b) and 6(c) show the proximity panel implemented in a different layer than a display panel and a multi-touch panel, this need not be the case. In some alternative embodiments, the multi-touch panel, the display device and the proximity sensors can be provided at the same layer. For example, the multi touch, proximity sensor and display functionalities can all be provided in the thin film transistor (TFT) layer of an LCD display. As discussed above, in some embodiments, multi-touch functionality need not be provided. In some of these embodiments, the display and proximity sensor functionalities can both be provided in the TFT layer of an LCD. Alternatively, both the display and proximity sensing functionalities can be provided in the LED layer of an OLED display.

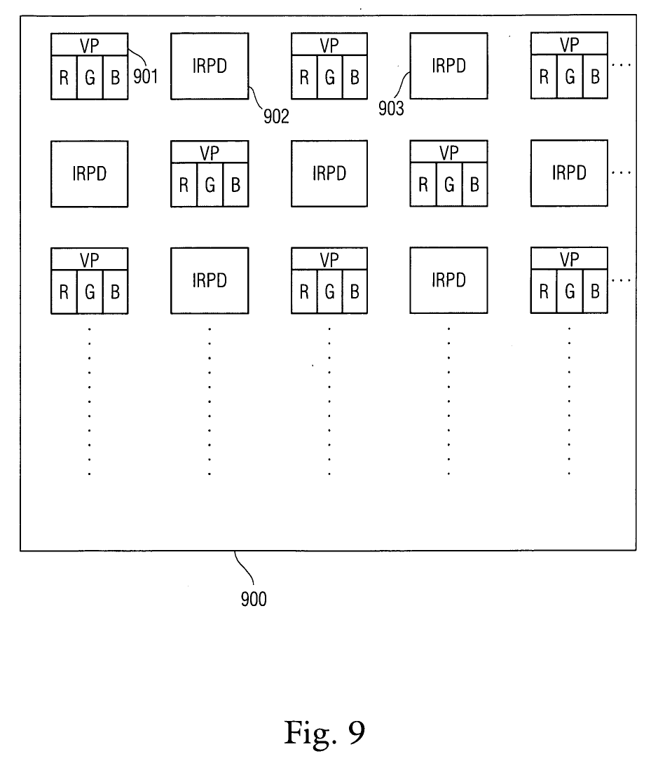

FIG. 9 is a diagram of an exemplary combined display and proximity sensing layer 900. This can be either the TFT layer of an LCD display or the LED layer of an OLED display. The display layer can include a plurality of visual pixels (VPs, such as VP 901) and infra red photodiodes (IRPDs, such as IRPD 902). VPs can be various electronic elements used as pixels in the display. In some embodiments VPs can include red, green and blue sub-pixels (or cells) identified as R, G and B as shown in FIG. 9. In some embodiments, the VPs can be the TFT pixel circuits that create magnetic fields which control the liquid crystals in an LCD display. In other embodiments, the VPs can be sets of organic LEDs in an OLED display (the R, G and B cells being LEDs of those particular colors).

The IRPDs can be IR diodes used to transmit and receive IR radiation for proximity sensing. Each IRPD can include a transmitting diode (e.g. an LED) or a receiving diode (e.g. a photodiode). Alternative IRPDs can include different types of diodes (thus, for example, IRPD 902 can include a transmitting diode, while IRPD 903 can include a receiving one).

Alternatively, each IRPD can include a diode that can perform both the transmission and receiving functions. Thus, each IRPD can either transmit IR or detect IR depending on various signals received from a controller of the panel. In yet another alternative, each IRPD can include two diodes—one transmitting and one receiving.

The IRPDs can be connected through one or more transmission lines to a controller of the panel. The controller can send signals to cause the transmitting diodes to transmit IR radiation and receive signals from the receiving IR diodes. In some embodiments, the connection can be such that each diode can be individually controlled. As mentioned above, this can be achieved, for example, using the same technique utilized for connecting the pixels of an ordinary LCD display (i.e., by using column and row transmission lines and connecting the column and row transmission lines to a transistor at each IRPD).

In some embodiments, the IRPDs can use their own dedicated transmission lines. In other embodiments, the IRPDs can share the transmission lines of neighboring VPs. In these embodiments, the display and proximity sensing functions can be time multiplexed. In other words, the transmission lines can be used to control/energize the VPs for a first time period, and then the transmission lines can be switched for controlling/energizing the IR transmitters and receiving signals from the IR receivers during a second time period. Thus, use for the display and proximity sensing functions can alternate. This multiplexing can be performed at a sufficiently high frequency to prevent any noticeable flicker.

In some OLED display embodiments, all IRPDs can be transmitting diodes. Receiving of reflected IR radiation may be performed by diodes within the VPs. Because the R, G, B cells within the various VPs in OLED displays include LEDs, these LEDs can be used to receive IR radiation and send it to a controller. In these embodiments, the display and proximity sensing functions can again be time multiplexed to allow the diodes within the VPs to perform IR sensing when they are not emitting light for the display.

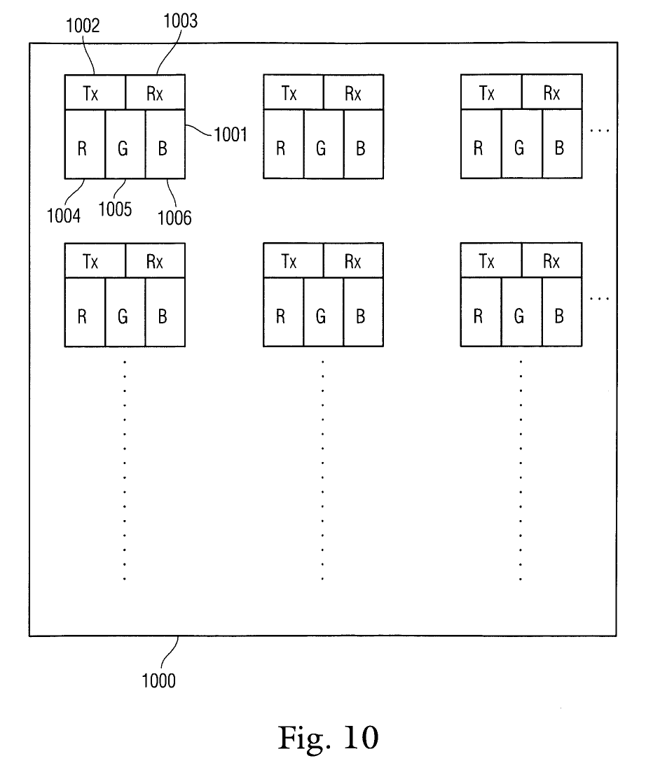

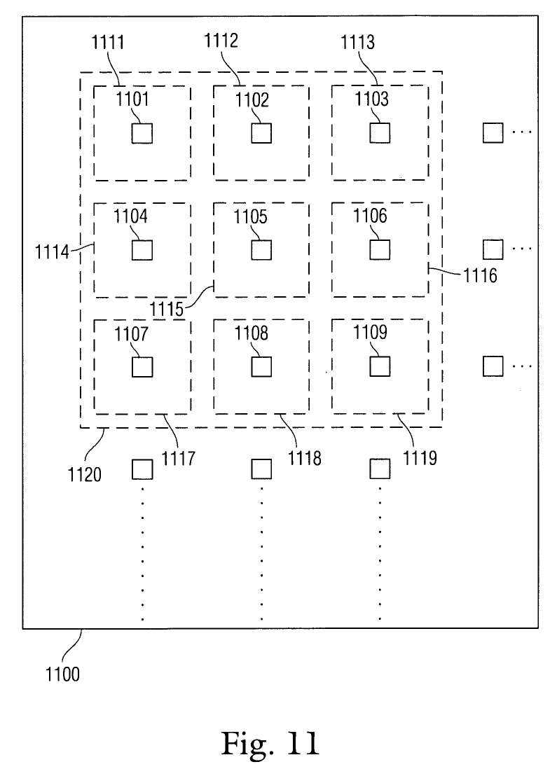

FIG. 10 is a diagram of another exemplary combined display and proximity sensing layer (layer 1000). In layer 1000, the IR transmitters and receivers can be combined with the display circuits in a single pixel. Thus, pixel 1001 can include transmitter and receiver cells 1002 and 1003, and R, G and B display cells 1004, 1005 and 1006. The transmitter and receiver cells can be IR diodes.

The display of FIG. 10 can be an LCD or TFT display. In an LCD display, the R, G and B cells can be TFT pixel circuits that create magnetic fields which control the liquid crystals in an LCD display. In an OLED display, the R, G and B cells can be LEDs.

The layer of FIG. 10 can have similar features and options as the layer of FIG. 9. For example, the transmission cells (such as cell 1002) can be individually controllable. The IR transmitting and receiving cells can be connected to a controller through dedicated transmission lines, or they can share transmission lines with the R, G and B cells. The IR cells and the R, G and B cells can operate concurrently or in a time multiplexed manner. In OLED embodiments, only IR transmission cells (such as cell 1002) can be present. Instead of IR receiving cells, the R, G and B cells can receive IR signals.

The layout of FIGS. 9 and 10 can be a cost efficient way to add proximity sensing to a display, because the layer 900 (or 1000) is already required to provide display functionality. Adding additional elements to a semiconductor layer that must already be produced can represent a relatively low incremental cost. Furthermore, for the OLED embodiments, it can be cost efficient to add proximity sensing functionality to an existing display, as this requires adding a set of LEDs to an OLED layer that already primarily comprises LEDs. The only difference is that the added LEDs may need to transmit or receive IR radiation, while the existing LEDs may operate on visible light.

FIG. 11 is a diagram of an exemplary proximity sensing panel according to embodiments of the present invention. Panel 1100 can include multiple proximity transmitters, such as transmitters 1101-1109 (other transmitters can also be present, as shown). These can be IR LEDs as discussed above. Each transmitter can transmit radiation that can be reflected from an object above it to detect proximity events. Thus, each transmitter can be used to detect proximity events in an adjacent area and volume(e.g. areas 1111-1119 for transmitters 1101-1109, respectively). Various IR receivers (not shown) can be used to detect reflected IR radiation.

Some embodiments of the invention provide that various transmitters can be selectively disabled and enabled. Thus, some embodiments can selectively vary the number of active transmitters in order to save power (by reducing the number of active transmitters) or improve accuracy (by increasing that number). Thus, for example, transmitters 1101-1104 and 1106-1109 can be deactivated, leaving only transmitter 1105 active. This can result in significant power savings, while reducing the accuracy (or granularity) of the proximity sensor panel. When only transmitter 1105 is active, a much larger volume (area 1120 and the volume above it) is being served by that transmitter. This can reduce the accuracy of the sensor panel as a tradeoff of saving power.

In some embodiments, the sensor panel is part of a device that dynamically determines a required accuracy depending on a task that is currently performed and activates/deactivates transmitters accordingly in order to provide the desired accuracy while conserving power.

In some embodiments, all IR receivers can be kept operational, because the receivers themselves do not usually consume any power. In other embodiments, IR receivers can themselves be selectively turned on and off to control power and granularity, because circuitry for processing the signals produced by IR receivers may consume power.

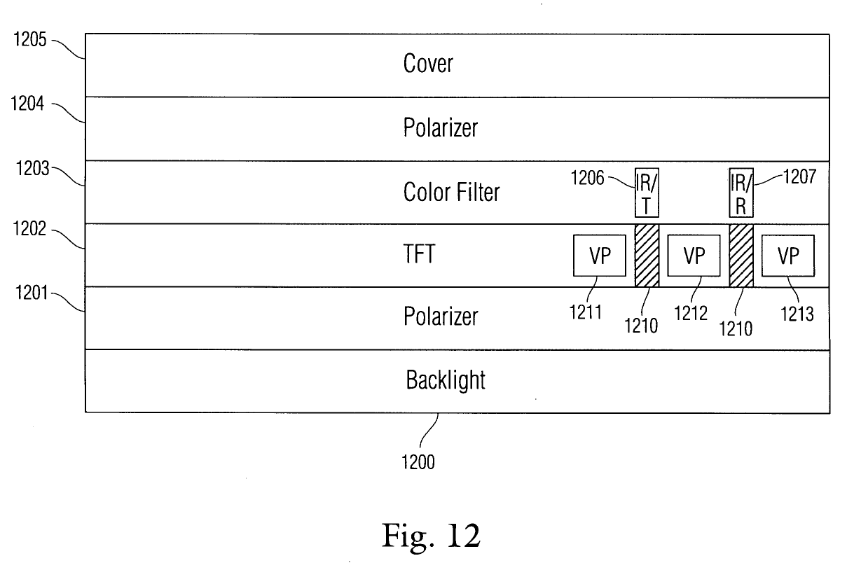

FIG. 12 is a diagram of an exemplary display including proximity sensor functionality according to some embodiments of the invention. The display of FIG. 12 includes several layers: a Backlight layer 1200, a polarizer layer 1201, a thin film transistor (TFT) layer 1203, a second polarizer layer 1204 and a cover layer 1205. As discussed above in the context of FIGS. 9, 10 and 11, in some embodiments the proximity sensing functionality can be provided in the TFT layer. In other embodiments, a separate proximity sensing layer can be used (see, e.g., FIGS. 6(b), 6(c)).

However, in yet other embodiments, the proximity sensing functionality (i.e., the IR transmitters and receivers) can be placed in one of layers 1200, 1201, 1203, 1204 or 1205. For example, the IR transmitters and receivers can be placed in the color filter layer 1203 so as to line up with a black mask of the TFT layer.

A black mask can be a mask placed between the various pixels and/or cells of the TFT layer. Thus, as shown in FIG. 12, black mask barriers 1210 separate visual pixels 1211-1213. Infrared transmitters and receivers, such as IR transmitter 1206 and IR receiver 1207, can be placed above the black mask barriers in the color filter layer. Thus, the infrared transmitters and receivers need not obstruct light passing from the backlight layer through the color filter layer. In other embodiments, the infrared transmitters and receivers can be placed in another layer above the black mask, such as the polarizer of cover layers 1204 and 1205. The transmitters and receivers can be placed between TFT pixels or even between individual cells (e.g., R, G, and B cells) within a pixel.

In some embodiments, the IR transmitters and receivers can be placed in any of layers 1200, 1201, 1203, 1204, and 1205 but not lined up with the black mask. Instead, alternative methods can be used to ensure that they do not interfere with the display. For example the IR transmitters and receivers can be made of transparent material or they can be of a comparatively small size.

In one alternative, the backlight layer 1200 can include an optical diffuser and the IR transmitters and receivers can be placed within that diffuser.

While embodiments of the present invention are discussed in connection with certain types of display technologies (such as LCD and OLED), they are not thus limited, but may encompass various other display technologies. While embodiments are discussed in connection with IR radiation, the invention is not thus limited. Other types of radiation can be used instead of IR radiation, and other types of known transmitters and receivers for such radiation can be used instead of IR transmitters and receivers.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A proximity sensing panel, comprising:
a plurality of transmitters disposed throughout the proximity sensing panel and configured to emit radiation from a front surface of the proximity sensing panel; and
a plurality of receivers disposed throughout the proximity sensing panel, each receiver configured to receive radiation emitted by one or more of the plurality of transmitters.

2. The proximity sensing panel of claim 1, further comprising a plurality of connections configured to connect the plurality of transmitters to control logic, the plurality of connections enabling the control logic to selectively activate a first group of transmitters from the plurality of transmitters while keeping inactive a second group of transmitters from the plurality of transmitters.

3. The proximity sensing panel of claim 2, wherein the plurality of connections are further configured to allow the control logic to deactivate the first group of transmitters while activating the second group of IR transmitters.

4. The proximity sensing panel of claim 3, wherein the plurality of connections are further configured to allow the control logic to activate any transmitter from the plurality of transmitters while keeping inactive any other transmitter from the plurality of transmitters.

5. The proximity sensing panel of claim 1, wherein the transmitters are infrared radiation (IR) transmitters, the receivers are IR receivers and the radiation is IR radiation.

6. A proximity sensing display comprising a semiconductor layer, the semiconductor layer comprising:
a plurality of picture element (pixel) cells configured to emit or control visible light for displaying images at the display;
a plurality of transmitters configured to emit radiation for proximity sensing; and
a plurality of receivers configured to receive radiation emitted from the IR transmitters and reflected by an object in proximity to the proximity sensing display.

7. The proximity sensing display of claim 6, wherein the transmitters and receivers are infrared (IR) light emitting diodes (LEDs) and the radiation is IR radiation.

8. The proximity sensing display of claim 6, wherein:
the proximity sensing display is a liquid crystal display (LCD);
the semiconductor layer is a TFT layer of the LCD; and
the transmitters and receivers are IR LEDs.

9. The proximity sensing display of claim 6, wherein:
the proximity sensing display is an organic light emitting diode (OLED) display; and
the plurality of transmitters and receivers are IR OLEDs.

10. The proximity sensing display of claim 6, further comprising a plurality of connections configured to connect the plurality of transmitters to control logic, the plurality of connections enabling the control logic to selectively activate a first group of transmitters from the plurality of transmitters while keeping inactive a second group of transmitters from the plurality of transmitters.

11. The proximity sensing display of claim 10, wherein the plurality of connections are further configured to allow the control logic to deactivate the first group of transmitters while activating the second group of transmitters.

12. The proximity sensing display of claim 11, wherein the plurality of connections are further configured to allow the control logic to activate any transmitter from the plurality of transmitters while keeping inactive any other transmitter from the plurality of infrared transmitters.

13. The proximity sensing display of claim 10, wherein at least one connector of the plurality of connectors is shared between an transmitter and a pixel cell.

14. The proximity sensing display of claim 13, wherein the display is configured to operate in two alternating modes comprising:
a first mode in which the pixel cell is active and the transmitter is inactive, the at least one shared connector being used by the pixel cell in the first mode;
a second mode in which the pixel cell is inactive and the transmitter is active, the at least one shared connector being used by the transmitter in the second mode.

15. A proximity sensing organic light emitting diode (OLED) display comprising a semiconductor layer, the semiconductor layer comprising:
a plurality of picture element (pixel) LEDs configured to emit or control visible light for displaying images at the display; and
a plurality of transmitter LEDs configured to emit radiation for proximity sensing;
wherein one or more of the plurality of pixel LEDs are further configured to receive IR radiation emitted from one or more of the plurality of transmitters and reflected by an object for proximity sensing.

16. The proximity sensing OLED display of claim 15, wherein the display is configured to operate in two alternating modes, the modes comprising:
a first mode in which the plurality of transmitters are inactive and the pixel LEDs are used to display images at the display; and
a second mode in which at least one or more of the plurality of transmitters are active and one or more of the pixel LEDs receives radiation emitted from one or more of the plurality of transmitters and reflected by an object.

17. The proximity sensing OLEd display of claim 15, wherein the radiation is infrared (IR) radiation and the transmitter LEDs are IR transmitters.

18. A proximity sensing liquid crystal display (LCD), comprising:
a backlight layer;
a thin film transistor (TFT) layer supported on the backlight layer;
a color filter layer supported on the TFT layer;
a cover layer supported on the color filter layer;
one or more visible pixel elements provided in the TFT layer, the visible pixel elements comprising electric circuits for magnetically affecting liquid crystals within the color filter layer; and
a plurality of radiation transmitters and receivers for proximity sensing.

19. The proximity sensing LCD display of claim 18, wherein the plurality of transmitters and receivers are provided in the TFT layer.

20. The proximity sensing LCD display of claim 18, wherein the plurality of transmitters and receivers are provided in the backlight layer.

21. The proximity sensing LCD display of claim 18, wherein the plurality of transmitters and receivers are provided in a polarizer layer between the backlight and TFT layers.

22. The proximity sensing LCD display of claim 18, wherein:
the TFT layer includes a black mask; and
the plurality of IR transmitters and receivers are placed above respective portions of the black mask in one layer selected from the group containing the color filter layer, the cover layer, and a polarizer layer positioned between the color filter and cover layers.

23. The proximity sensing LCD display of claim 18, wherein the radiation transmitters and receivers are infrared (IR) transmitters and receivers.

24. A portable audio player comprising the proximity sensing LCD display of claim 18.

25. A mobile telephone comprising the proximity sensing LCD display of claim 18.

26. A portable audio player comprising a proximity sensing liquid crystal display (LCD), comprising:
a backlight layer;
a thin film transistor (TFT) layer supported on the backlight layer;
a color filter layer supported on the TFT layer;
a cover layer supported on the color filter layer;
one or more visible pixel elements provided in the TFT layer, the visible pixel elements comprising electric circuits for magnetically affecting liquid crystals within the color filter layer; and
a plurality of radiation transmitters and receivers for proximity sensing.

27. A mobile telephone comprising a proximity sensing liquid crystal display (LCD), comprising:
a backlight layer;
a thin film transistor (TFT) layer supported on the backlight layer;
a color filter layer supported on the TFT layer;
a cover layer supported on the color filter layer;
one or more visible pixel elements provided in the TFT layer, the visible pixel elements comprising electric circuits for magnetically affecting liquid crystals within the color filter layer; and
a plurality of radiation transmitters and receivers for proximity sensing.

28. A method for providing proximity sensing over a surface area, comprising:
emitting radiation at a first plurality of locations arranged throughout the surface area; and
receiving reflected radiation from the first plurality of locations at a second plurality of locations arranged throughout the surface area.

29. The method of claim 28, further comprising emitting the radiation from within a liquid crystal display (LCD).

30. The method of claim 28, further comprising receiving the reflected radiation from within a liquid crystal display (LCD).

31. The method of claim 28, wherein the radiation is infrared (IR) radiation.

32. A method for operating a proximity sensing panel, comprising
activating a first group of transmitters from a plurality of transmitters disposed throughout the proximity sensing panel while keeping one or more other transmitters of the plurality of transmitters inactive;
deactivating the first group of transmitters while activating a second group of transmitters, the second group being selected from transmitters that are not in the first group; and
detecting radiation transmitted from the first and second groups of transmitters.

33. The method of claim 32, wherein the radiation is infrared (IR) radiation, the transmitters are IR transmitters and the receivers are IR receivers.

34. The method of claim 32, further comprising activating and deactivating the first group of transmitters from within a liquid crystal display (LCD).

35. The method of claim 32, further comprising detecting the IR radiation from within a liquid crystal display (LCD).

36. A method for operating a proximity sensing display comprising, a plurality of picture elements (pixels), a plurality of transmitters, and a plurality of receivers, the method comprising:
operating one or more of the plurality of pixels to create a visible image;
operating two or more of the plurality of transmitters to emit radiation from the display;
operating one or more of the plurality of receivers to receive radiation emitted from the display and reflected by an object in proximity to the display; and
sending one or more results signals to a controller, the results signals being based on the received radiation.

37. The method of claim 36, wherein the radiation is infrared (IR) radiation, the transmitters are IR transmitters and the receivers are IR receivers.

38. The method of claim 36, further including processing the results signals at the controller to detect the object.

39. The method of claim 36, further comprising selectively deactivating one or more of the plurality of transmitters to reduce power.

40. The method of claim 36, further comprising:
determining a region of the display in which proximity sensing is not necessary; and
deactivating one or more transmitters in the region of the display in which proximity sensing is not necessary.

41. The method of claim 36, further comprising:
determining a time or region of the display wherein a reduced granularity of proximity sensing is sufficient;
deactivating one or more IR transmitters during the determined time or in the determined region in order to reduce the granularity of proximity sensing and reduce power.

42. A method for manufacturing a proximity sensing display, comprising:
forming a first semiconductor processing layer; and
combining a plurality of picture element cells, transmitters and receivers in the first layer,
wherein the picture element cells are configured to emit or control visible light for displaying images at a display, the transmitters are configured to emit radiation, and the receivers are configured to receive radiation transmitted by the transmitters and reflected by an object in proximity to the proximity sensing display.

43. The method of claim 42, wherein the radiation is infrared (IR) radiation, the transmitters are IR transmitters and the receivers are IR receivers.

44. A method for operating a proximity sensing display, comprising:
displaying images at the display using a plurality of picture elements by selectively controlling or emitting visible light by the picture elements;
transmitting radiation from a plurality of transmitters; and
receiving radiation reflected by an object in proximity to the sensing display at a plurality of receivers,
wherein the picture elements, the transmitters and the receivers are all semiconductor elements formed on a single semiconductor layer.

45. The method of claim 44, wherein the radiation is infrared (IR) radiation, the transmitters are IR transmitters and the receivers are IR receivers.
